(19) United States
(12) Patent Application Publication
(10) Pub. No.: US 2013/0229379 A1
(43) Pub. Date: Sep. 5, 2013

(54) TOUCH SENSOR AND ASSOCIATED MANUFACTURING METHOD

(71) Applicants: Pascal Joguet, Sadirac (FR); Guillaume Largillier, Bordeaux (FR); Julien Olivier, Bordeaux (FR)

(72) Inventors: Pascal Joguet, Sadirac (FR); Guillaume Largillier, Bordeaux (FR); Julien Olivier, Bordeaux (FR)

(73) Assignee: STANTUM, Bordeaux (FR)

(21) Appl. No.: 13/883,802

(22) PCT Filed: Nov. 25, 2011
(86) PCT No.: PCT/FR2011/052767

§ 371 Date: May 7, 2013

(30) Foreign Application Priority Data
Nov. 26, 2010 (FR) 10/04617

(51) Int. Cl. G06F 3/041; B05D 5/12

(52) U.S. Cl. CPC G06F 3/041; B05D 5/12
USPC 345/173; 427/58; 427/123; 427/124

(57) ABSTRACT

A tactile sensor includes an insulating support including a first face including a first series of parallel conducting tracks and a second face including a second series of parallel conducting tracks, the insulating support being folded and the second face being disposed opposite the first face. The tactile sensor includes an array of conducting tracks extending in an edge zone intended to be folded, along fold lines. The tactile sensor can, for example, be used in a tactile control screen.

The present invention concerns a touch sensor, in particular for a touch-control screen.

It also concerns a method of manufacturing that touch sensor.

In general terms, the present invention concerns the field of touch sensors, and in particular multi-contact touch sensors enabling simultaneous detection of several zones of contact with the touch sensor of an object, such as a stylus or a user's finger.

When this touch sensor is associated with a display screen, a touch-control screen is constituted making it possible, according to the elements displayed on the display screen (graphical object, icon, image) to generate actions for controlling an item of software or equipment and/or for manipulating the displayed elements by taking into account the data acquired from the transparent touch sensor.

Such a touch sensor is known, which is described in particular in the document EP 1 719 047.

This touch sensor comprises a first layer comprising a first series of parallel conductive tracks and a second layer comprising a second series of parallel conductive tracks, the two layers being superposed against each other such that the first series of parallel conductive tracks is perpendicular to the second series of parallel conductive tracks.

A row/column array of conductive tracks is this obtained, making it possible, through detection of a variation in impedance (resistance, capacitance) at the location of each crossing zone of conductive tracks, to detect the presence of an object (stylus, user's finger) on the touch sensor, opposite that crossing zone.

This row/column array of conductive tracks thus constitutes the touch detection zone of the touch sensor.

Conventionally, the first layer is formed from a plate of glass on which is formed the first series of parallel conductive tracks.

The second layer is formed from a flexible film, for example of PET (acronym for Polyethylene Terephthalate), cut out to the dimensions of the glass plate and on which is formed the second series of parallel conductive tracks.

A network of conductive tracks is also formed on the glass plate and on the flexible film to connect the parallel conductive tracks to a connecting member forming an interface with an external processor.

An insulating protective layer is then deposited on the network of conductive tracks to provide the electrical insulation thereof.

A double-sided adhesive layer is cut out to the dimensions of the flexible film and of the glass plate, then deposited on the glass plate to enable the subsequent bonding of the flexible film to that glass plate and out form the row/column array of the conductive tracks of the touch detection zone of the touch sensor.

This manufacturing method includes a high number of operations, with manipulations of different parts which are difficult to automate.

Also known in document U.S. Pat. No. 5,159,159 is a method of manufacturing a touch sensor in which the two series of parallel conductive tracks are formed on two adjacent faces of a foldable insulating substrate.

This insulating substrate is folded face against face to form the row/column array constituting the touch detection zone, that is to say the active zone of the touch sensor.

However, such a touch sensor also comprises a network of conductive tracks which extend in the vicinity of the active zone and constitute, in the plane of the touch sensor, an inactive zone

It is then necessary to find a compromise between the size of those inactive zones, which unnecessarily increases the size of the touch sensor, and which must however be sufficient to enable the disposition of the network of conductive tracks, linking the conductive tracks of the active zone to a processor for controlling the touch sensor.

Thus, when that touch sensor is associated with a display screen, a frame is for example provided to mask the inactive part of the touch sensor, leading to a greater dimension for the touch screen than that of the active zone proper.

The present invention aims to solve at least one of the aforesaid drawbacks and to provide a method of manufacturing a touch sensor and such a touch sensor without dimension constraint of the inactive zones disposed along the edges of the touch sensor.

To that end, according to a first aspect, the present invention concerns a touch sensor, comprising an active zone comprising a first series of parallel conductive tracks and a second series of parallel conductive tracks, the second series of parallel conductive tracks being perpendicular to the first series of parallel conductive tracks, said first and second series of parallel conductive tracks being formed on an insulating substrate having a first face comprising said first series of parallel conductive tracks and a second face comprising said second series of parallel conductive tracks, the insulating substrate being folded and said second face being disposed facing said first face.

According to the invention, the insulating substrate further comprises a network of conductive tracks connecting the first and second series of parallel conductive tracks to a zone for connection with an external processor, the network of conductive tracks extending in at least one edge zone disposed between the active zone and a side of the insulating substrate, the insulating substrate comprising a fold line between the active zone and said at least one edge zone.

Forming an insulating substrate by folding enables simple provision of a row/column array of conductive tracks forming a touch detection zone in the touch sensor.

The network of conductive tracks enabling management of the signals provided or read on the row/column array of the parallel conductive tracks may be formed in one piece on the insulating substrate up to the zone for connection with an external processor.

Thanks to the fold line between the active zone and an edge zone bearing conductive tracks of the network, the touch sensor has, after folding of the edge zones, a flat surface of smaller size, able to substantially match the active zone proper of the touch sensor or to adapt to the dimensions of a given display screen.

The size of the active surface of such a touch sensor is thus improved relative to the dimension or bulk in a plane of that touch sensor.

It is possible that surface occupied by the touch sensor in a plane may be substantially equal to the active zone proper of that touch sensor.

Furthermore, since the edge zones bearing the network of conductive tracks may be folded, their width may be greater to facilitate the disposition of the network of conductive tracks.

In practice, the insulating substrate is a film of thickness comprised between 20 and 200 μm and preferably between 25 and 50 μm, enabling a touch sensor of small thickness to be formed by folding.

In a practical embodiment of the invention, the insulating substrate comprises a wing forming an extension on one side of the insulating substrate, adapted to form the zone for connection with an external processor, the insulating substrate comprising a fold line between the active zone and an edge disposed between the active zone and said side of the insulating substrate.

Thus, the connection zone of the touch sensor may be formed as a single piece in the insulating substrate.

Furthermore, the connection zone formed by the wing of the insulating substrate may be folded under the active zone of the touch sensor, so enabling direct mounting of that touch sensor on an electronic board.

According to an advantageous embodiment of the invention, the insulating substrate further comprises control circuits associated with each conductive track of the first and second series of parallel conductive tracks, the network of conductive tracks extending between the control circuits and the zone for connection with an external processor.

By thus placing control circuits on the insulating substrate which are associated with each conductive track of the row/column array, it is possible to reduce the number of conductive tracks connected to an external processor, which are necessary for the provision and/or the reading of the electrical signals on each conductive track of the row/column array.

In practice, the first and second series of conductive tracks and the network of conductive tracks are produced from metal, such as silver or copper.

The use of a metallic material for producing the conductive tracks of the touch sensor is particularly advantageous, provided those conductive tracks can be folded with the insulating substrate without loss of conductivity nor wear over time despite the curvature imposed upon those conductive tracks at the location of the insulating substrate fold lines.

In a practical embodiment, making it possible in particular to maintain transparency for the touch sensor in its active zone, each conductive track of the first and second series of parallel conductive tracks comprises at least one metal wire of width less than 20 μm.

In order to give each conductive track sufficient resistivity, each conductive track comprises several metal wires extending substantially parallel to each other and connected together at one of their ends.

According to a second aspect the present invention concerns a method of manufacturing a touch sensor comprising an active zone comprising a first series of parallel conductive tracks and a second series of parallel conductive tracks, said second series of parallel conductive tracks being perpendicular to said first series of parallel conductive tracks.

According to the invention, this manufacturing method comprises the following steps:
forming the first and second series of parallel conductive tracks respectively on adjacent zones of an insulating substrate;
forming a network of conductive tracks connecting the first and second series of parallel conductive tracks to a zone for connection with an external processor, the network of conductive tracks extending in at least one edge zone disposed between said active zone and a side of the insulating substrate;
depositing an insulating film on the network of conductive tracks;
folding the insulating substrate along a fold line extending between the two adjacent zones; and
folding the insulating substrate along a fold line extending between the active zone and said at least one edge zone.

Thus manufacturing method enables a row/column array of conductive tracks in a touch sensor to be formed in a particularly simplified manner.

This method is particularly advantageous relative to the manufacturing techniques in which the connection zone is an added-on part, fastened to the touch detection zone and thus requiring precise positioning in the alignment of the conductive tracks located at the junction with the connection zone.

The network of conductive tracks may thus be formed before folding. An insulating film also makes it possible, before folding, to avoid any contact with the conductive tracks of that network.

In an advantageous embodiment of the invention, it further comprises a step of forming control circuits on the insulating substrate which are each associated with each conductive track of the first and second series.

It is thus possible to reduce the number of conductive tracks of the network for connection with an external processor.

Lastly, according to a third aspect, the present invention concerns a touch-control screen, comprising a touch sensor in accordance with the invention and a display screen which are superposed.

This touch-control screen has features and advantages which are similar to those described in relation to the touch sensor.

In practice, the active zone of the touch sensor extends above the display screen, the edge zone or zones being folded along an edge of said display screen or between the touch sensor and the display screen.

Thus, the touch sensor and its active surface may adapt as well as possible to the various dimensions of the display screens.

More particularly, when the touch sensor comprises a wing forming an extension on one side of the insulating substrate, and that is adapted to form the zone for connection with an external processor, that wing is folded under the display screen, thus enabling the touch sensor to be directly connected to an electronic system for management of that sensor disposed on the electronic board placed under the touch-control screen.

Still other particularities and advantages of the invention will appear in the following description.

In the accompanying drawings, given by way of non-limiting example:

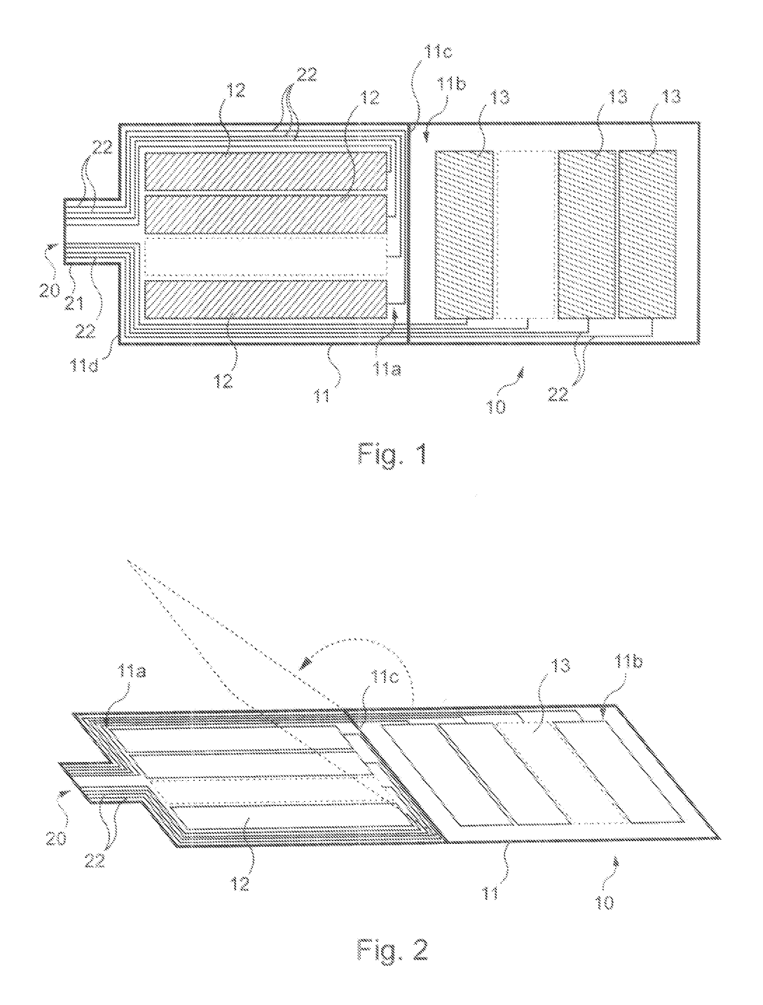

FIGS. 1 and 2 are diagrammatic views illustrating the manufacture of a touch sensor in accordance with a first embodiment of the invention;

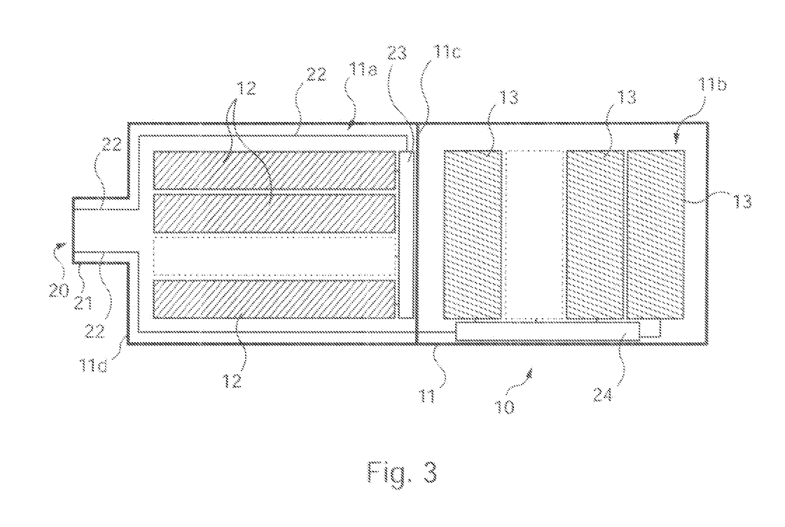

FIG. 3 is a similar view to FIG. 2 illustrating a touch sensor according to a second embodiment of the invention;

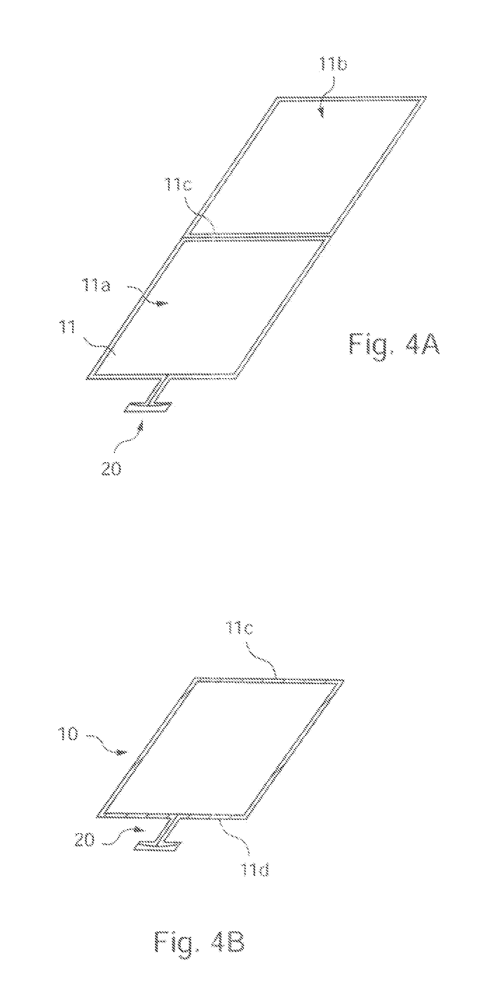

FIGS. 4A and 4B diagrammatically illustrate a first touch sensor structure in accordance with the invention;

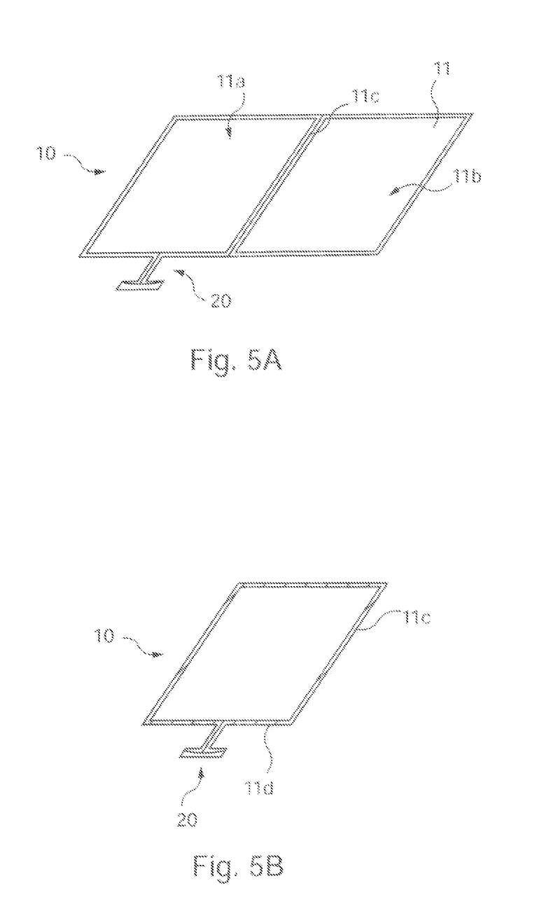

FIGS. 5A and 5B diagrammatically illustrate a second touch sensor structure in accordance with the invention;

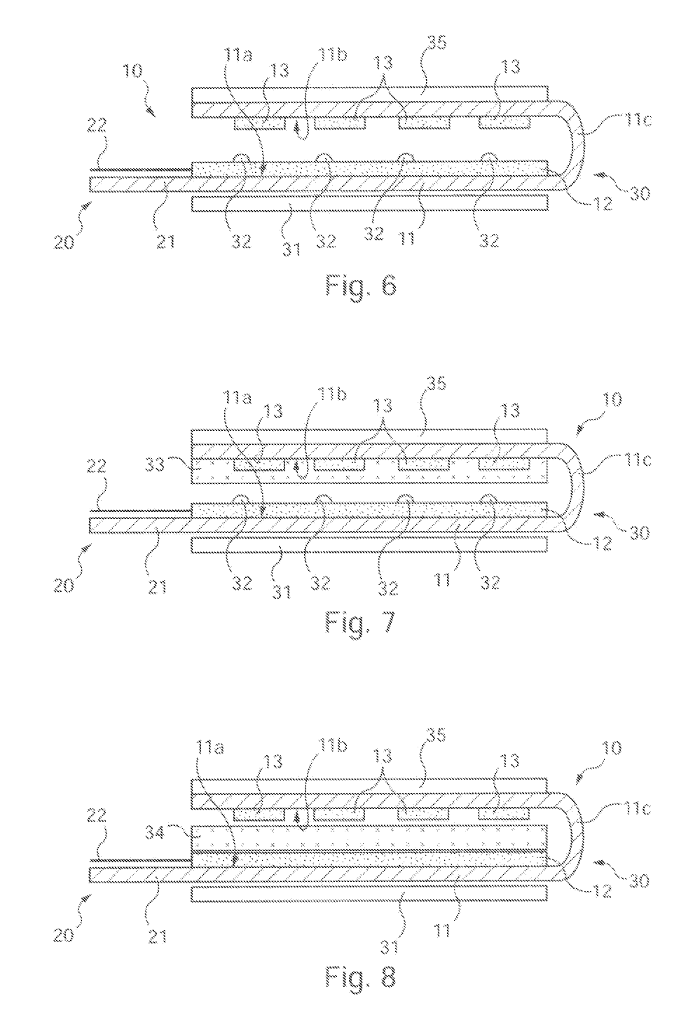

FIG. 6 is a diagrammatic illustration in cross-section of a touch-control screen according to a first embodiment of the invention;

FIG. 7 is a diagrammatic illustration in cross-section of a touch-control screen according to a second embodiment of the invention;

FIG. 8 is a diagrammatic illustration in cross-section of a touch-control screen according to a third embodiment of the invention;

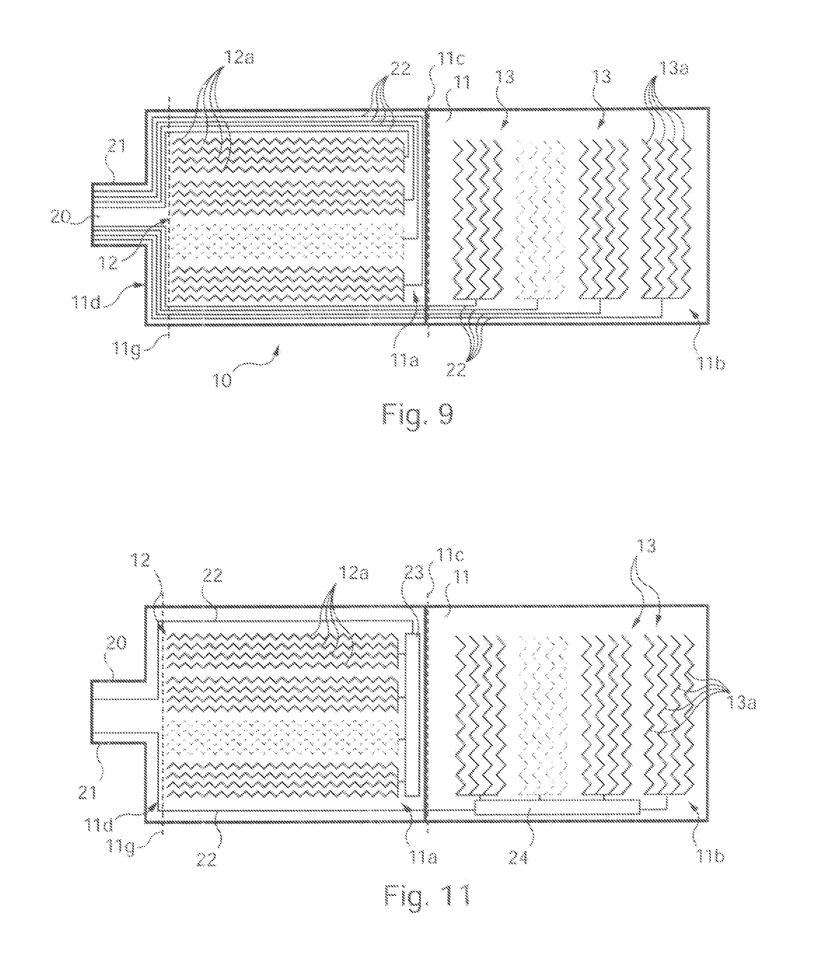

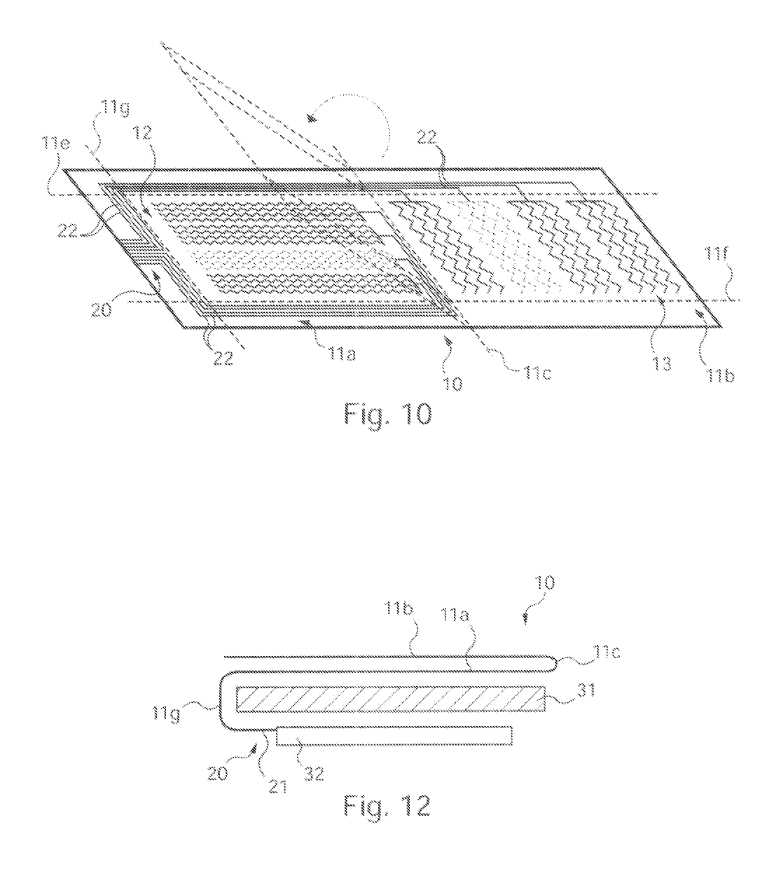

FIGS. 9 and 10 are diagrammatic views illustrating the manufacture of a touch sensor in accordance with a third embodiment of the invention;

FIG. 11 is a similar view to FIG. 9 illustrating the manufacture of a touch sensor according to a fourth embodiment of the invention;

FIG. 12 is a diagrammatic cross-section view of a touch-control screen according to a fourth embodiment of the invention; and

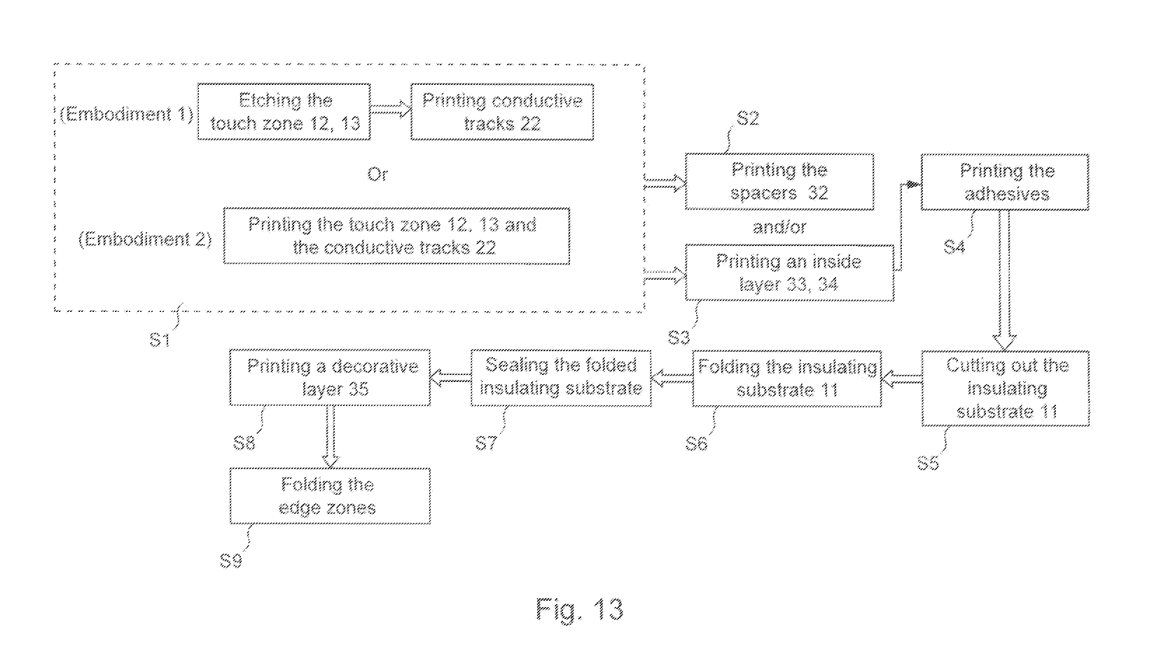

FIG. 13 is an algorithm illustrating the steps of a method of manufacturing a touch sensor according to an embodiment of the invention.

A description will first of all be made with reference to FIGS. 1 and 2 of a touch sensor according to a first embodiment of the invention.

In general terms, such a touch sensor 10 comprises a touch detection zone, enabling for example multi-contact detection, that is to say adapted to simultaneously detect several points of pressing or of pressure applied to the surface of the touch sensor 10.

To that end, as illustrated in FIG. 1, the touch sensor 10 comprises on an insulating substrate 11a first series of parallel conductive tracks 12 and a second series of parallel conductive tracks 13.

The first series of parallel conductive tracks 12 is formed on a first zone 11a of the insulating substrate.

The second series of parallel conductive tracks 13 is formed on a second zone 11b of the insulating substrate 11, the first zone 11a and the second zone 11b being adjacent on the insulating substrate 11.

As illustrated in FIG. 2, the insulating substrate 11 of the touch sensor 10 is folded along a fold line 11c, extending between the two adjacent zones 11a, 11b.

In this folded position of the insulating substrate 10, the first zone 11a thus constitutes a first face 11a of the insulating substrate comprising the first series of parallel conductive tracks 12 and the second zone 11b constitutes a second face 11b of the insulating substrate 11 comprising the second series of parallel conductive tracks 13.

In the folded position, the second face 11b of the insulating substrate 11 is thus disposed facing the first face 11a of the insulating substrate 11 such that the first series of parallel conductive tracks 12 and the second series of parallel conductive tracks 13 are also disposed face-to-face.

The disposition of the first series of parallel conductive tracks 13 is such that in folded position, the first series of parallel conductive tracks 12 is perpendicular to the second series of parallel conductive tracks 13.

A touch detection zone is thus formed in the touch sensor 10 at the location of the first and second faces 11a, 11b disposed facing each other.

More particularly, the first series of parallel conductive tracks 12 and the second series of parallel conductive tracks 13 constitute a row/column array of conductive tracks thus defining crossing zones or points at the location of which the detection of a variation in impedance makes it possible to detect the presence of an object opposite that crossing zone.

Reference may advantageously be made to the description of document EP 1 719 047 for a more detailed description of the detection of the pressing points on such a touch sensor 10, in particular by detection of the variation in the resistance at the location of pressing point.

As clearly illustrated in FIGS. 1 and 2, the insulating substrate 11 is preferably of substantially rectangular shape, the two adjacent zones 11a, 11b being separated by a fold line 11c extending widthwise of the insulating substrate 11.

The first series of parallel conductive tracks 12 is disposed in a first direction on the first zone 11a of the insulating substrate 11 and the second series of parallel conductive tracks 13 is disposed in a second direction, perpendicular to the first direction, on the second zone 11b of the insulating substrate 11.

The insulating substrate 11 is thus folded widthwise, along the fold line 11c.

In addition to the row/column array so constituted, the touch sensor 10 also comprises means making it possible to manage the operation of the touch detection zone, and in particular to provide an electrical signal or read such an electrical signal at the terminals of the first series of parallel conductive tracks 12 and of the second series of parallel conductive tracks 13.

To that end, the touch sensor 10 comprises a connection zone 20 adapted to be connected with an external processor (not illustrated) in order to manage the operation of the touch sensor 10.

In the embodiment as illustrated in FIGS. 1 and 2, the insulating substrate comprises a wing 21 thus forming an extension on one side 11d of the insulating substrate 11.

Here, the wing 21 is integrally formed in the material constituting the insulating substrate 11 and forms an extension on one edge 11d of the insulating substrate 11, corresponding to an edge which extends widthwise of that insulating substrate 11.

In a manner that is in no way limiting, in this embodiment, the wing 21 thus constitutes a substantially rectangular tab extending in the middle of the edge 11d of the insulating substrate 11.

It is to be noted with reference to FIG. 2 that when the insulating substrate 11 is folded along the fold line 11c, that connection zone 20 remains visible and extends beyond the first face 11a and second face 11b opposite the touch sensor 10.

This connection zone 20 thus enables the subsequent connection of the touch sensor 10 to a microprocessor or other element necessary for its operation.

The insulating substrate 11 further comprises a network of conductive tracks 22 which extends between each conductive track of the first and second series of conductive tracks 12, 13 and the connection zone 20.

This network of conductive tracks 22 thus enables the passage of an electric current for the supply of each conductive track or for reading an electrical signal on each conductive track of the touch detection zone.

In such a touch sensor 10, and according to the resolution and the size of the touch sensor, a very high number of parallel conductive tracks 12, 13 is provided. For example, the first series of parallel conductive tracks 12 may comprise 2000 tracks whereas the second series of parallel conductive tracks 13 may comprise 1500 tracks.

The embodiment described in FIGS. 1 and 2 thus requires the formation of 3500 conductive tracks 22 for the operation of the touch sensor 10 so formed.

Of course, this number of conductive tracks 12, 13, 22 is given as being in no way limiting and solely to illustrate the high number of conductive tracks to form on such a touch sensor.

In order to simplify the network of conductive tracks 22, it is possible, as illustrated in FIG. 3, to provide control circuits 23, 24 on the insulating substrate 11 which are respectively associated with each conductive track of the first and second series of parallel conductive tracks 12, 13.

These control circuits 23, 24 constitute drivers such that the network of conductive tracks 22 may be simplified when only conductive tracks 22 extending between the control circuits 23 and 24 and the connection zone 20 are necessary for the operation of the touch sensor 10.

Thus, when the row/column array is scanned, the control circuits 23, 24 make it possible to control the supply of electric current to a series of parallel conductive tracks, and for example the first series of parallel conductive tracks 12, as well as the measurement of an electrical parameter on the other series of parallel conductive tracks, and in this example, of the second series of parallel conductive tracks 13.

The network of conductive tracks 22 enabling the control circuits 23, 24 to be supplied and controlled may thus be simplified in terms of the number of conductive tracks 22.

Whatever the embodiment illustrated in FIG. 1 or 3, it is necessary to provide an insulating film (not shown) disposed on the network of conductive tracks 22 such that when the insulating substrate 11 is folded along the fold line 11c, the conductive tracks 22 of the network do not come into contact with each other, disturbing the passage of the electrical signals.

In FIGS. 4A and 4B a first embodiment for manufacturing a touch sensor in accordance with the invention has been illustrated, also corresponding to the embodiment described in FIG. 1 or 3.

Thus, in this manufacturing embodiment, the fold line 11c extends widthwise of the insulating substrate 11 and, after folding as illustrated in FIG. 4B, corresponds to an edge of the touch sensor 10 extending widthwise of the touch sensor 10 of substantially rectangular shape.

As clearly illustrated in FIG. 4A the connection zone 20 thus extends on an opposite edge 11d to the edge constituted by the fold line 11c of the touch sensor 10.

Alternatively, as illustrated in FIGS. 5A and 5B, the fold line 11c of the insulating substrate 11 may extend widthwise of the insulating substrate 11 and, after folding, constitute a longitudinal edge 11c of the touch sensor 10.

In this manufacturing embodiment, the connection zone 20 extends on an edge 11d corresponding to the width of the touch sensor 10 and which is perpendicular to the longitudinal edge constituted by the fold line 11c of the insulating substrate 11.

Of course, these example embodiments are not limiting, it being possible for the connection zone 20 to extend at any other location on an edge of the touch sensor 10.

Furthermore, different embodiments of a touch-control screen have been illustrated in FIGS. 6 to 8.

This touch-control screen 30 comprises a display screen, disposed here under a touch sensor 10 corresponding to a touch sensor as described above with reference to FIGS. 1 to 3.

In such a structure, it is thus necessary for the touch sensor 10 to be transparent in order to enable the elements displayed on the underlying display screen 31 to be viewed.

Of course, other embodiments of a touch-control screen based on a touch sensor 10 as described above could be employed.

In particular, the display screen could be disposed above the touch sensor 10 provided that the display screen is sufficiently flexible to enable transmission of a press made on the display screen to the surface of the underlying touch sensor.

In such a case, the touch sensor is not necessarily transparent.

In the first embodiment illustrated in FIG. 6, a series of spacers 32 (also called spacer dots) is disposed between the first and second faces 11a, 11b facing the folded insulating substrate 11.

These spacers 32 so disposed between the first series of parallel conductive tracks 12 and second series of parallel conductive tracks 13 make it possible to maintain a space between the two faces 11a, 11b of the insulating substrate 11, in order to avoid the parallel conductive tracks 12, 13 being placed in contact.

This series of spacers 32 thus enables the parallel conductive tracks 12, 13 of the row/column array in the touch detection zone of the touch sensor 10 to be kept insulated by a layer of air.

It is also possible as illustrated in the second embodiment of FIG. 7, to furthermore add an inner resistive layer 33 disposed between the first and second faces 11a, 11b opposite the folded insulating substrate 11.

As is known in the state of the art, such an inner resistive layer 33 makes it possible to eliminate the re-passage of the current through the row/column array of the touch sensor 10, and thus eliminate masking effects or ghosts.

In a third embodiment as illustrated in FIG. 8, the inner resistive layer 33 and the series of spacers 32 may be replaced by an inner layer 34 of variable resistance also disposed between the first and second faces 11a, 11b opposite the folded insulating substrate 11.

This inner layer 34 has the particularity of being formed from a material of which the resistance varies according to the pressure applied to that material such that it is also possible by measuring the variation in the resistance, to evaluate the pressing force applied on the touch sensor at a pressing point thanks to the variation in the resistance in the inner layer 34.

The variable resistance inner layer 34 may be produced from known materials such as a contact pressure sensitive polymer layer or an FSR ink (FSR standing for “Force Sensitive Resistor”), or even a gel or foam with a conductive particle filler.

This variable resistance inner layer 34 makes it possible both to insulate the parallel conductive tracks 12, 13 of the row/column array, to eliminate the re-passage of the current through that array and to evaluate the pressing force at the pressing point or points on the touch sensor.

When the touch sensor 10 is adapted, as in this embodiment, to be disposed above a display screen 31, it may further comprise a decorative layer 35 (also called a coverlens).

This decorative layer 35 may thus be bonded onto an outside face of the insulating substrate 11, and for example here on the back of the second face 11b of the insulating substrate 11 bearing the second series of parallel conductive tracks 13.

With reference to FIGS. 9 and 10 a third embodiment of a touch sensor will now be described.

This touch sensor has similar features to those of the embodiments described above with reference to FIGS. 1 and 2, the parts in common bearing the same reference numbers.

This touch sensor 10 is modified mainly as regards the constitution of the first and second series of parallel conductive tracks 12, 13.

Here, the first and second series of conductive tracks 12, 13 are produced from metal, such as silver or copper.

In the example embodiment described below, the metal used is for example silver.

This same material is used to form the network of conductive tracks 22 connecting the parallel conductive tracks 12, 13 to the connection zone 20.

The use of such a metal material, such as silver, instead of ITO to form the network of conductive tracks 22 makes it possible to give that network of conductive tracks 22 satisfactory properties of bending and durability over time, in particular at the location of the fold lines of the insulating substrate 11, and in particular the fold line 11c enabling the two adjacent faces 11a, 11b of the insulating substrate 11 to be disposed facing each other.

When a transparent touch sensor is formed, the network of conductive tracks 22 may be opaque provided that those conductive tracks are placed outside the active zone proper of the touch sensor 10.

Thus, the constitution of that network of conductive tracks 22 from silver, an opaque material, is not a drawback for producing a transparent touch sensor.

On the other hand, the parallel conductive tracks 12, 13 of the active zone of the touch sensor 10 must be invisible to preserve the transparency of the touch sensor 10.

In practice, each conductive track 12, 13 comprises one or more metal wires 12a, 13a of width less than 20 μm.

Preferably, the width of each metal wire 12a, 13a produced from silver is of the order of 10 μm.

In order to obtain the desired resistivity for each conductive track 12, 13 of the active zone of the touch sensor 10, the conductive tracks 12, 13 of the touch detection zone are constituted by several metal wires 12a, 13a linked together at one end in the form of a comb.

The number of metal wires 12a, 13a so extending parallel to each other to constitute a conductive track 12, 13 depends on the desired resistivity, and is comprised between 3 and 5.

In a manner which is in no way limiting, in the example illustrated in FIGS. 9 and 10, the number of metal wires 12a, 13a constituting each conductive track 12, 13, is four.

In order to avoid the moiré effect and improve the visual comfort of the user, the metal wires 12a, 13a may be disposed in saw tooth configuration, parallel to each other.

By way of example, by disposing several metal wires 12a, 13a parallel to each other, with a predetermined spacing between each metal wire 12a, 13a, the total width of an active track 12, 13 may be comprised between 0.5 and 3 mm, each metal wire 12a, 13a having a width of the order of 10 μm.

Thus, the transparency of the touch sensor 10 in the active zone is preserved.

By virtue of the possible bending of the conductive tracks thus formed from a metallic material, and as illustrated in FIG. 10, the insulating substrate 11 may comprise fold lines, in addition to the fold line 11c disposed between the two adjacent faces 11a, 11b of the touch sensor already described above.

Thus, as illustrated in FIG. 10 in this embodiment, the insulating substrate 11 comprises for example three other fold lines 11e, 11f, 11g.

These fold lines 11e, 11f, 11g extend between the active zone bearing the first series of conductive tracks 12 and the second series of conductive tracks 13 and an edge zone disposed between that active zone and one side of the insulating substrate 11.

As the network of conductive tracks 22 extends in those edge zones, those zones may be folded at each fold line 11e, 11f, 11g.

Thus, as clearly illustrated in FIG. 9, when the insulating substrate 11 comprises a wing 21 forming an extension on one side lid of the insulating substrate 11, to form the connection zone 20, that insulating substrate 11 comprises a fold line 11g between the active zone and an edge zone disposed between that active zone and the side lid of the insulating substrate 11.

The network of conductive tracks 22 disposed in that edge zone may thus be folded under the touch sensor 10.

In another alternative as illustrated in FIG. 10, it is possible for the connection zone 20 of the network of conductive tracks 22 not to be formed on an extension wing of the insulating substrate 11, the edge 11d of the insulating substrate 11 not being cut out.

Thanks to the folding of that edge zone between the active zone and the edge 11d of the insulating substrate, all the conductive tracks 22 extending in the connection zone 20 may be disposed under the touch sensor 10 to enable direct connection to a driver of the sensor, mounted on an electronic board.

In general terms, the fold lines 11e, 11f, 11g extend substantially parallel to one side of the insulating substrate 11.

In this embodiment, a fold line 11g extends parallel to the side 11d of the insulating substrate 11, corresponding to the width of the insulating substrate 11.

Two other fold lines 11e, 11f extend parallel to the longitudinal sides of the insulating substrate 11.

Furthermore, the disposition of those fold lines 11e, 11f, 11g between the active zone and each side of the insulating substrate 11 may be variable, and in particular those fold lines 11e, 11f, 11g may extend at a variable distance from the active zone proper.

It will be noted that advantageously, as the edge zones bearing the network of conductive tracks 22 can be folded, the dimension of those edge zones is no longer a constraint.

In particular, each edge zone may have any width, taken in a direction perpendicular to the side of the insulating substrate 11, which width may be adapted to the number of tracks of the network of conductive tracks 22 disposed on that edge zone, parallel to that same side of the insulating substrate 11.

In FIG. 11, a fourth embodiment of such a touch sensor has been illustrated.

This fourth embodiment is identical in every way to those described above in relation to FIG. 9, except for the formation of the network of conductive tracks 22 which has been modified. As described above in relation to FIG. 3, control circuits (drivers) 23, 24 are integrated onto the insulating substrate 11, so limiting the number of conductive tracks of the network of conductive tracks 22 which extends between the control circuits 23, 24 and the zone 20 for connection with an external processor.

As illustrated in FIG. 12, when this touch sensor 10 is juxtaposed against a display screen 31 to constitute a touch-control screen, the edge zones bearing the network of conductive tracks 22 may be folded along the edges of the display screen 31.

As clearly illustrated in FIG. 12, when the touch sensor 10 comprises a wing 21 forming an extension on one side 11d of the insulating substrate 11, as illustrated in FIG. 9, that wing 21 may be folded under the display screen 31 such that the zone 20 for connection with an internal processor is disposed under the display screen 31 and may be directly connected to an electronic board 32 bearing the external control processor of the touch sensor 10.

A method of manufacturing such a touch sensor will now be described with reference to FIG. 13.

The first step of the method of manufacturing the touch sensor 10 consists of a step S1 of forming the first and second series of parallel conductive tracks 12, 13 on adjacent zones 11a, 11b of an insulating substrate 11.

Preferably, this insulating substrate is a film of small thickness, comprised for example between 20 and 200 μm, and preferably between 25 and 50 μm.

This small thickness must enable easy folding of that insulating substrate 11.

In a manner that is not limiting, the insulating substrate 11 is produced from a transparent PET film in order to ensure the transparency of the touch sensor 10.

According to a first manufacturing embodiment, at the step S1 of forming the parallel conductive tracks 12, 13 later constituting the touch detection zone of the touch sensor 10, a technique of etching a homogenous conductive layer deposited in advance on the insulating substrate 11 is implemented.

This homogenous conductive layer may for example be formed of ITO (acronym for Indium Tin Oxide) which has the particularity of being transparent.

As described above in relation with FIGS. 9 to 12, the material used may alternatively be silver.

It is possible in that homogenous conductive layer to form, by etching, all the parallel conductive tracks 12, 13 of the touch zone as well as the conductive tracks 22 of the connection network, up to the connection zone 20.

Alternatively, and as illustrated in FIG. 13, only the parallel conductive tracks 12, 13 may be formed by the technique of etching the homogeneous conductive layer, the network of conductive tracks 22 being formed by a printing technique, of the ink jet printing type or by vacuum deposition.

Alternatively, according to a second manufacturing embodiment, all the parallel conductive tracks 12, 13 and the network of conductive tracks 22 may be formed by a printing technique.

The printing may be formed by printing a conductive ink on the insulating substrate of PET type, deposited by ink jet or vacuum deposition.

When the conductive tracks 12, 13 of the active zone of the touch sensor 10 are formed from several silver metal wires, of width of the order of 10 μm, the deposition of those metal wires is preferably carried out by ink jet printing or laser deposition.

A technique for manufacturing conductive tracks formed from one or more metal wires of very small width, and in particular less than 80 μm, is described in particular in the document FR 2 925 717.

Taking into account the folding of the insulating substrate 11, the materials used (conductive layer to etch or ink to print) to form the network of conductive tracks 22 by printing or etching must be sufficiently flexible to maintain their electrical properties despite the fold line 11c of the insulating substrate 11.

In general terms, the radius of curvature of the insulating substrate 11 in the fold zone, which is proportional to the thickness of the touch sensor, must be determined according to the tolerance of the conductive ink at the location of that fold zone.

A conductive track formed from conductive ink must therefore be able to be folded with that radius of curvature without breaking.

By way of non-limiting example, if the insulating substrate is formed from a PET film of 50 μm thickness, and an insulating film is disposed on the network of conductive tracks 22 with a thickness of the order of 100 μm, the conductive ink used to form the network of conductive tracks 22 must be able to be folded without modifying its electrical properties with a radius of curvature substantially equal to 50 μm.

Forming the network of conductive tracks 22 on the insulating substrate 11 enables integral formation of those conductive tracks which extend between each parallel conductive track 12, 13 of the row/column array up to the wing 21 forming the connection zone 20 of the touch sensor.

This production technique enables the manufacturing of the touch sensor to be simplified, in particular in that connection zone 20.

Furthermore, at the step of forming the conductive tracks 22, is also possible to form control circuits 23, 24 on the insulating substrate 11 such as are described earlier with reference to the embodiment illustrated in FIG. 3.

The control circuits 23, 24 so printed at the location of each parallel conductive track 12, 13 of the row/column array may then be managed by an addressing signal from a multiplexing system, requiring fewer conductive tracks 22.

After step S1 of forming the conductive tracks 12, 13 of the touch detection zone and the network of conductive tracks 22, a step S2 of printing the spacers 32 may be performed.

Alternatively or successively, a step S3 of printing an inner resistive layer 33, 34 may be performed.

As described above with reference to FIGS. 7 and 8, this inner resistive layer may either be an inner resistive layer 33 of stable resistance, thus requiring the presence of spacers 32 to ensure spacing between the parallel conductive tracks 12, 13 in the touch detection zone, or be an inner resistive layer of variable resistance.

This printing steps S2, S3 may be carried out by conventional printing techniques or by vacuum disposition on the insulating substrate 11.

A step S4 of printing adhesive elements is also carried out.

It makes it possible in particular to deposit an insulating film that is bonded on the network of conductive tracks 22 in order to ensure insulation of those conductive tracks 22 after folding of the insulating substrate 11.

The insulating film may thus be formed from a double-sided adhesive layer enabling both to insulate the conductive tracks of the network of conductive tracks 22 and then to provide bonding at the location of the edges of the folded insulating substrate 11.

These adhesive elements may be deposited using a mask placed on the insulating substrate 11 in order to limit the area coated with the adhesive, and in particular to avoid the disposition of adhesive and/or insulation on the touch detection zone.

Glue or adhesive may be deposited over the entirety of the edges of the insulating substrate 11 or else over only three or four edges of one of the zones 11a or 11b of the insulating substrate 11, the deposit of glue or adhesive at the location of the fold line 11c of the insulating substrate 11 not being necessary.

Of course, the deposition of glue or adhesive may also be carried out along continuous lines or at separate points, for example at the corners of each adjacent zone 11a, 11b adapted to come to face each other. It should be noted that these different steps S1, S2, S3, S4 may be carried out successively on the same continuous printing machine having several printing stations dedicated to each step of forming S1 and printing S2, S3, S4.

The insulating substrate 11 is next cut out to the dimensions of the touch sensor 10 in a cutting-out step S5.

Further to this cutting-out step S5, the touch sensor thus has a substantially rectangular shape and is provided with its wing 21 in the connection zone 20, already provided with the network of conductive tracks 22.

A folding step S6 next enables the insulating substrate 11 to be folded along a first fold line 11c in order to dispose the two faces 11a, 11b of the insulating substrate 11 face to face with each other.

A sealing step S7 may be carried out in order to ensure bonding at the edges of the touch sensor 10.

This sealing step S7 may be carried out by passing the folded insulating substrate 11 through a rolling mill.

Optionally, the manufacturing method may also comprise a step S8 of printing a decorative layer 35 on one of the visible faces of the folded insulating substrate 11.

The touch sensor 10 so formed may then be bonded onto a display screen in order to form a touch-control screen as illustrated in FIGS. 6 to 8.

When a touch sensor 10 as illustrated in FIGS. 9 to 11 is manufactured, the manufacturing method further comprises a step S9 of folding of the edge zones.

As described above, when this folding step S9 takes place, the touch sensor 10 is folded at the edge zones, along fold lines 11e, 11f, 11g.

In particular, the edge zone bearing the connection zone 20 may be folded at a fold line 11g and be disposed under the display screen 31.

The edge zones bearing a network of conductive tracks but not requiring any connection to an external processor may themselves be folded directly under the touch sensor 10, that is to say between the surface of the touch sensor 10 and the display screen 31, at the fold lines 11e, 11f of the touch sensor 10.

In this case, the insulating substrate 11 is folded at the fold lines 11e, 11f through 180° in order to be disposed under the touch sensor 10.

This type of fabrication may be used when the touch sensor 10 is not transparent or else if the edge zones so folded do not extend directly under the transparent active surface of the touch sensor 10.

Alternatively, the edge zones bearing a network of conductive tracks not requiring any connection to an external processor may be folded along the edges of the display screen.

In this case, the insulating substrate is folded at the fold lines 11e, 11f through 90°, such that the edge zones extend along the display screen substantially perpendicularly to the active surface of the touch sensor 10.

The manufacturing method so described makes it possible to manufacture a touch sensor at lower cost with a limited number of steps, in particular through implementing techniques of printing or etching the different electrical circuits on the same insulating substrate.

Thus, all the circuits necessary for the operation of the touch sensor may be formed in simultaneous or successive printing steps on the same insulating film.

This manufacturing method in particular makes it possible to dispense with the alignment of the conductive tracks in the connection zone.

When the touch sensor furthermore incorporates control circuits at the location of each conductive track 12, 13 of the row/column array, the limited number of conductive tracks 22 necessary for managing the operation of the touch sensor makes it possible to further reduce the production cost of such a touch sensor.

Of course, the present invention is not limited to the example embodiments described above.

Thus, in the embodiment described in relation with FIGS. 9 and 10, it is possible for the insulating substrate 11 to comprise only some of the fold lines 11e, 11f, 11g at the location of the edge zones, and for example only one fold line 11g at the location of an edge zone of the insulating substrate 11 bearing the connection zone 20.

1-20. (canceled)

21. A touch sensor comprising:
an active zone comprising a first series of parallel conductive tracks and a second series of parallel conductive tracks, the second series of parallel conductive tracks being perpendicular to the first series of parallel conductive tracks,
the first and second series of parallel conductive tracks being formed on an insulating substrate having a first face comprising the first series of parallel conductive tracks and a second face comprising the second series of parallel conductive tracks,
the insulating substrate being folded and the second face being disposed facing the first face,
wherein the insulating substrate further comprises a network of conductive tracks connecting the first and second series of parallel conductive tracks to a zone for connection with an external processor, the network of conductive tracks extending in at least one edge zone disposed between the active zone and a side of the insulating substrate, the insulating substrate comprising a fold line between the active zone and the at least one edge zone.

22. A touch sensor according to claim 21, wherein the insulating substrate comprises a wing forming an extension on one side of the insulating substrate, configured to form the zone for connection with an external processor, the insulating substrate comprising the fold line between the active zone and an edge disposed between the active zone and the side of the insulating substrate.

23. A touch sensor according to claim 21, wherein the insulating substrate is a film of thickness between 20 and 200 μm, or between 25 and 50 μm.

24. A touch sensor according to claim 21, wherein the insulating substrate is formed from a film of transparent PET.

25. A touch sensor according to claim 21, wherein the first and second series of conductive tracks and the network of conductive tracks are formed from metal, or silver or copper.

26. A touch sensor according to claim 25, wherein each conductive track of the first and second series of parallel conductive tracks comprises at least one metal wire of width less than 20 μm.

27. A touch sensor according to claim 26, wherein each conductive track comprises plural metal wires extending substantially parallel to each other and connected together at one of their ends.

28. A touch sensor according to claim 21, wherein the insulating substrate further comprises control circuits associated with each conductive track of the first and second series of parallel conductive tracks, the network of conductive tracks extending between the control circuits and the zone for connection with an external processor.

29. A touch sensor according to claim 21, further comprising an insulating film deposited on the network of conductive tracks.

30. A touch sensor according to claim 21, further comprising a series of spacers disposed between the first and second faces facing the folded insulating substrate.

31. A touch sensor according to claim 36, further comprising an inner resistive layer disposed between the first and second faces facing the folded insulating substrate.

32. A touch sensor according to claim 21, further comprising a variable resistance inner layer disposed between the first and second faces facing the folded insulating substrate, the resistance varying according to pressure applied on the inner layer.

33. A method of manufacturing a touch sensor, including an active zone including a first series of parallel conductive tracks and a second series of parallel conductive tracks, the second series of parallel conductive tracks being perpendicular to the first series of parallel conductive tracks, the method comprising:
forming the first and second series of parallel conductive tracks respectively on adjacent zones of an insulating substrate;
forming a network of conductive tracks connecting the first and second series of parallel conductive tracks to a zone for connection with an external processor, the network of conductive tracks extending in at least one edge zone disposed between the active zone and a side of the insulating substrate;
depositing an insulating film on the network of conductive tracks;
folding the insulating substrate along a fold line extending between the two adjacent zones; and
folding the insulating substrate along a fold line extending between the active zone and the at least one edge zone.

34. A manufacturing method according to claim 33, further comprising forming control circuits on the insulating substrate that are each associated with each conductive track of the first and second series.

35. A method of manufacturing according to claim 23, wherein at least one of the forming the first and second series of parallel conductive tracks of forming a network of conductive tracks implement a technique of printing metallic conductive ink, of ink jet printing type, or vacuum deposition.

36. A method of manufacturing according to claim 23, wherein at least one of the forming the first and second series of parallel conductive tracks of forming a network of conductive tracks implement a technique of etching a metallic homogenous conductive layer deposited in advance on the insulating substrate.

37. A method of manufacturing according to claim 23, further comprising sealing edges of the folded insulating substrate.

38. A touch-control screen, comprising a touch sensor in accordance with claim 21 and a display screen which are superposed.

39. A touch-control screen according to claim 38, wherein the active zone of the touch sensor extends above the display screen, the at least one edge zone being folded along an edge of the display screen or between the touch sensor and the display screen.

40. A touch-control screen according to claim 39, wherein the touch sensor comprises a wing forming an extension on one side of the insulating substrate, configured to form the zone for connection with an external processor, the wing being folded under the display screen.
